(19) United States
(12) Patent Application Publication
(10) Pub. No.: US 2013/0024427 A1
(43) Pub. Date: Jan. 24, 2013

(54) Method and Apparatus for Recovering Database Backup

(71) Applicant: Tao Long, Shenzhen (CN)

(72) Inventor: Tao Long, Shenzhen (CN)

(73) Assignee: ZTE CORPORATION, Shenzhen, Guangdong (CN)

(21) Appl. No.: 13/259,974

(22) PCT Filed: Nov. 22, 2010
(86) PCT No.: PCT/CN10/78972

§ 371 Date: Sep. 14, 2012

(30) Foreign Application Priority Data
Jul. 20, 2010 (CN) 201010233924.8

(51) Int. Cl. G06F 17/00

(52) U.S. Cl. 707/674; 707/E17.007

(57) ABSTRACT

A method and an apparatus for recovering a database backup is provided by the present invention, wherein the method comprises: backing up an old version database, wherein table structures of the old version database are stored; clearing records of all tables in a new version database, and acquiring table structures of the new version database; comparing the table structures of the old version database with the table structures of the new version database, and determining that the table structures changes; and recovering a backup of the old version database into the new version database according to a type of the change and a corresponding preset strategy. The forward compatibility of database backup recovery is achieved by the present invention.

### FIELD OF THE INVENTION

The present invention relates to the field of database, and in particular to a method and an apparatus for recovering a database backup.

### BACKGROUND OF THE INVENTION

In the related art, the design of database structure (including table structure and data content) often transits with the changes of function modules, and the difference between various versions may be relatively large. Since the table structure and the data content between a new version and an old version are incompatible, when the backup of a current database is recovered, the old version database backup cannot be recovered into a new version database with the design of the database structure having changed.

FIG. 1 shows a flow chart of a method for recovering a database backup in the related art. The process procedure usually used is as follows.

(1) An old version database is started.

(2) A new version database is started.

(3) The record of all the tables in the new version database is cleared.

(4) Whether each new and old table has changed is judged artificially.

(5) For a table with no change, the record of each table with the same table structures in the old database is migrated into the new database by using the data migration tool provided by a database management system.

(6) For each table with different table structures in the old database, which columns need to be discarded and which columns need to be performed such special strategies as data type conversion are judged by using the data migration tool provided by the database management system, and the record is migrated into the new database after a corresponding operation type is selected.

(7) If the record content of certain tables still requires special modifications to meet the requirements of the new version program, then a series of the sql sentences can be executed, or some programs can be executed to process.

The data recovery ends.

The process of the above steps is very cumbersome, especially the three steps of (4), (5), and (6), and in the cases that there are many tables, the operation is rather timeconsuming.

### SUMMARY OF THE INVENTION

A method and an apparatus for recovering a database backup are provided by the present invention to achieve the forward compatibility of database backup recovery.

According to one aspect of the present invention, a method for recovering a database backup is provided, comprising: backing up an old version database, wherein table structures of the old version database are stored; clearing records of all tables in a new version database, and acquiring table structures of the new version database; comparing the table structures of the old version database with the table structures of the new version database, and determining that the table structures of the new version database changes; and recovering the backup of the old version database into the new version database according to a type of the change and a corresponding preset strategy.

According to another aspect of the present invention, an apparatus for recovering a database backup is provided, comprising: a backup module, configured to back up an old version database, wherein table structures of the old version database are stored; an acquiring module, configured to clear records of all tables in a new version database, and acquire table structures of the new version database; a comparing module, configured to compare the table structures of the old version database with the table structures of the new version database, and determine that the table structures of the new version database changes; and a recovering module, configured to recover the backup of the old version database into the new version database according to a type of the change and a corresponding preset strategy.

The present invention solves the problem in the related art that the backup of an old version database cannot be recovered into a new version database with the design of database structure having changed by analyzing the change of table structures, and thereby the forward compatibility of database backup recovery is achieved.

### BRIEF DESCRIPTION OF THE DRAWINGS

The drawings described herein are used to provide a further understanding of the present invention, which construct a part of the present invention. The exemplary embodiments and description of the present invention are used to explain the present invention, without unduly limiting the scope of the present invention. In the drawings:

FIG. 1 shows a flow chart of a method for recovering a database backup in the related art;

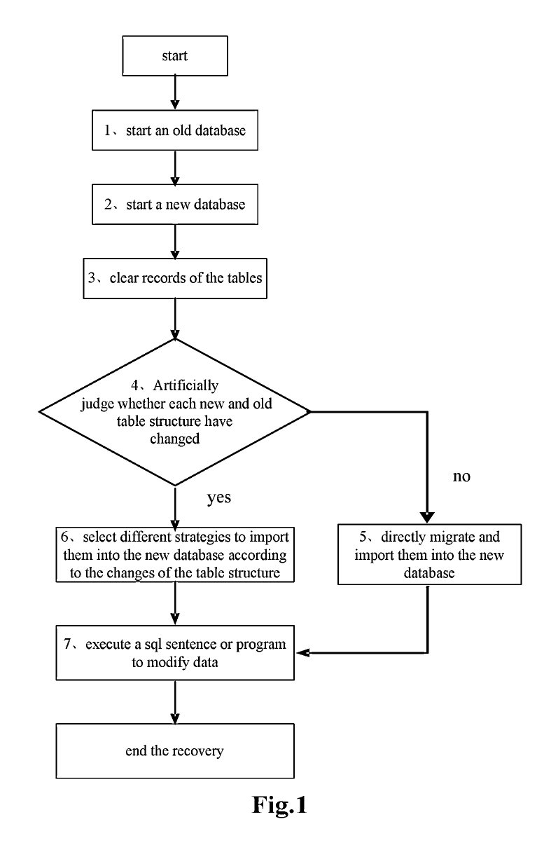

FIG. 2 shows a flow chart of a method for recovering a database backup according to one embodiment of the present invention;

FIG. 3 shows a flow chart of a method for recovering a database backup according to one preferred embodiment of the present invention; and

FIG. 4 shows a schematic diagram of an apparatus for recovering a database backup according to one embodiment of the present invention.

### DETAILED DESCRIPTION OF EMBODIMENTS

The present invention is described in detail with reference to the drawings in combination with the embodiments as follows. It needs to be explained that the embodiments of the application and the characteristics of the embodiments can be combined with each other if there is no conflict.

A database generally comprises a plurality of data tables, wherein each data table is consisted of a plurality of columns and each column has a data structure. The embodiments of the present invention are implemented on the basis of this database.

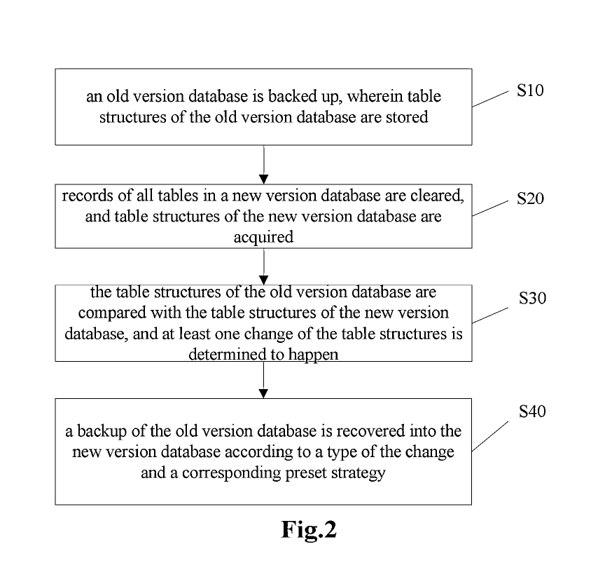

FIG. 2 shows a flow chart of a method for recovering a database backup according to one embodiment of the present invention, wherein the method comprises the steps as follows.

Step S10, an old version database is backed up, wherein table structures of the old version database are stored. For example, the required table structure information, table data and current version number in the old version are backed up and stored in the form of file.

Step S20, records of all tables in a new version database are cleared, and table structures of the new version database are acquired.

Step S30, the table structures of the old version database are compared with the table structures of the new version database, and at least one change of the table structures is determined to happen.

Step S40, the backup of the old version database is recovered into the new version database according to a type of the change and a corresponding preset strategy.

This embodiment solves the problem in the related art that the old version database backup cannot be recovered into a new version database with the design of database structure having changed by analyzing the change of the table structures, and thereby the forward compatibility of database backup recovery is achieved.

Preferably, the step that at least one change of the table structures is determined to happen comprises: at least one change as follows is determined to happen to the table structures of the new version database.

1. A table is deleted in the new version database.

2. A table is added in the new version database.

3. A table is renamed in the new version database.

4. A column is deleted in a table in the new version database.

5. A column is added in a table in the new version database.

6. A column is renamed in a table in the new version database.

7. An order of a column in a table changes in the new version database.

8. A data type of a column in a table changes in the new version database.

The above changes of the database structures may appear alone or may appear together by combination. For example, such case may appear in the new version: a certain table A is renamed as table B, and meanwhile a certain column a in table B is also deleted. Furthermore, the above tables or columns are not limited to one or more.

In this embodiment, various changes of the database structures are concluded to the above eight categories finally by a large amount of analysis and researches. The changes of the above eight categories can be easily identified by comparing the table structures.

Preferably, the corresponding preset strategy comprises at least one as follows.

1. For the change 1, the recovery of the deleted table is skipped over.

2. For the change 2, the recovery of the new added table is skipped over.

3. For the change 3, the renamed table in the backup is recovered into the renamed table in the new version database.

4. For the change 4, the recovery of the deleted column is skipped over.

5. For the change 5, if a default value is preset, then the new added column is set as the default value, and if no default value is preset, then the new added column is set as a NULL value, or an indicated value; or the recovery of the new added column is skipped over.

6. For the change 6, the renamed column in the backup is recovered into the renamed column in the new version database.

7. For the change 7, the column in the backup is recovered into the column in the new version database according to the new order.

8. For the change 8, the value of the column in the backup is converted into a new data type, and then the value is recovered into the column of the new version database. If the value cannot be converted, then the column of the new version database is recovered as a designated value.

By performing the above compatible processing, all eight changes of the structure design of the new and old version databases can be adapted, and thereby the forward compatibility of database backup recovery is well achieved, which can be applied to most of the scenarios.

Preferably, this method further comprises creating an XML file in advance, and recovering the backup of the old version database into the new version database by analyzing the XML file, wherein the XML file comprises at least one of the rules of performing the preset strategies 3, 5, 6, and 8. The preset strategies 3, 5, 6, and 8 are relatively special, and they are required to flexibly adapt to the user settings, so it is not suitable for them to be directly solidified into a program. However, the XML file can be easily edited by a user, so it is suitable for configuring the rules of the preset strategies 3, 5, 6, and 8.

Preferably, the XML file further comprises at least one rule as follows.

Column modification rule: indicating to set the value of a column designated in the new version database to be a default value.

Column deletion rule: indicating to set the value of a column designated in the new version database to be a NULL value.

Table modification rule: indicating to use the combination of the column modification rule and the column deletion rule for a plurality of columns in the table in the new version database.

Postprocessing rule: indicating to modify the data in the new version database by executing a SQL sentence or a dedicated code segment on the basis that the backup has been recovered into the new version database.

In some scenarios, the structure of the new version database may not change, but a user expects to freely set the content of the table in the new version database, i.e. the user does not desire to directly recover the content in the backup into the new version database but desire to be able to change the content during the recovery. However, this embodiment well meets the above requirements of the user by configuring the above rules in the XML file.

Preferably, this method further comprises creating an executive program in advance and directly executing at least one of the rules of the preset strategies 1, 2, 4, and 7 according to the executive program. Since the preset strategies 1, 2, 4 and 7 are relatively simple, and they do not require the user to configure, a program can be directly written in to relieve the burden of user operations and accelerate execution speed.

Preferably, the backup of the old version database is recovered into the new version database by means of bcp (block copy), which can increase the speed of recovering backup.

Preferably, the information of the table structures comprises: database name, table name, column name, column length and column data type. It can be very easy to judge whether the structures of the new and old version databases have changed by using the information.

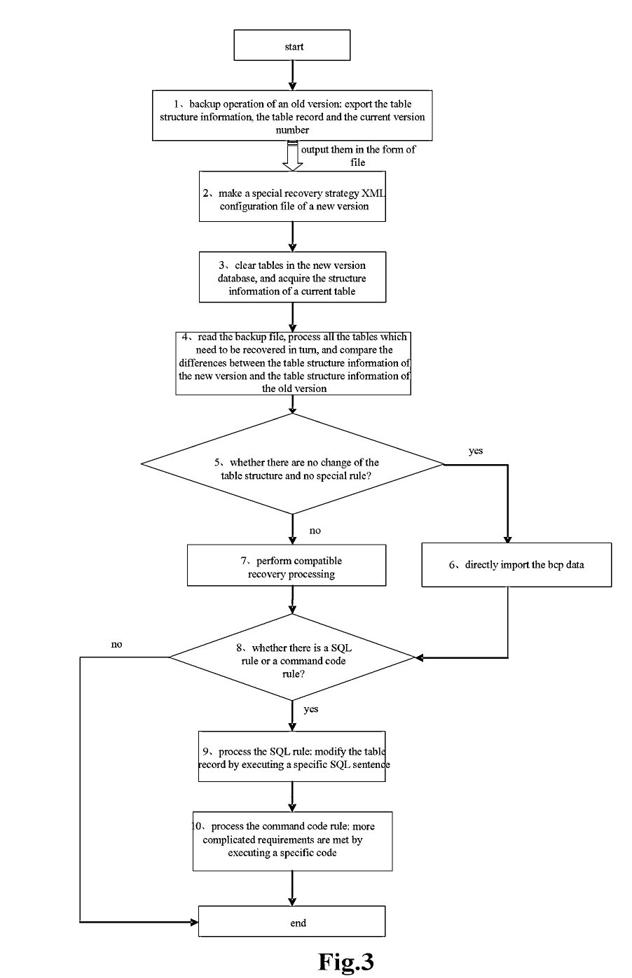

FIG. 3 shows a flow chart of a method for recovering a database backup according to one preferred embodiment of the present invention. This preferred embodiment combines the technical solutions of the above embodiments and comprises the steps as follows.

1. A backup operation is performed in an old version, the structure information, the table data and the current version number of all the relevant tables which need to be backed up are exported as files, and uniformly stored into a single folder.

2. For a new version, a special recovery strategy XML configuration file is created, and all the processing steps that require manual intervention are written into the XML configuration file according to a specific rule. In the situation that all differences can be automatically identified by the backup recovery program, then this XML configuration file can be set as NULL. The backup folder is copied into the new version software for starting to perform a recovery operation.

3. Firstly the records of all the relevant tables in the new version database are cleared, and the structure information of each table are acquired, which comprises database name, table name, all column names contained, column length and column data type.

4. The structure information of all the relevant tables backed up in the backup folder is read, each backup table is processed in turn, the differences between the table structure of the new version and the table structure of the old version are compared, and whether a special rule is preset in the XML configuration file is judged.

5. Whether there are no change of the table structure and no special rule is judged. If the judgment result is YES, then step 6 is performed, otherwise step 7 is performed.

6. If the table structure of the current backup table does not change and no specific recovery strategy is designated in the XML configuration file, then directly a table data file is imported by means of using the bcp, and the backup record is recovered into the database.

7. If the table structure of the current backup table changes or a specific recovery strategy is designated in the XML configuration file, then the recovery program performs compatible processing according to the specific rule.

8. After all the backup files are imported into the database, the SQL rule and the command code rule in the XML configuration file are checked. If there is no SQL rule, then the recovery process can be ended.

9. If there is a SQL rule, then all the SQL sentences designated in this rule are executed in turn to modify the current data in the database.

10. Finally the command code rule in the XML configuration file is checked, the specific code corresponding to each command code is executed in turn to modify the current data in the database.

The recovery operation ends.

Various compatibility problems of the database content are solved by this embodiment by means of combining the backup recovery program with the specific recovery strategy XML configuration file. The requirements of most application scenarios can be met by appropriately adjusting the rules of the XML file. At the same time, the speed of backup recovery can be improved by using the bcp import and export mode.

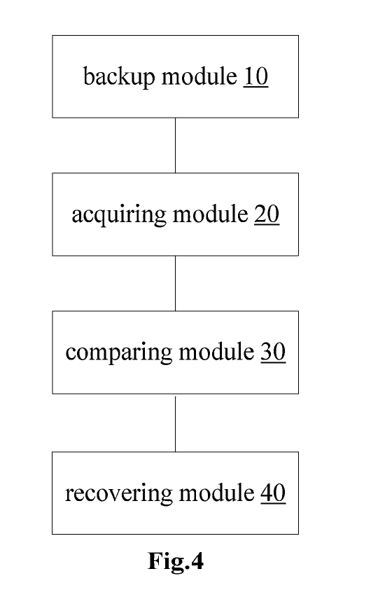

FIG. 4 shows a schematic diagram of an apparatus for recovering a database backup according to one embodiment of the present invention, wherein the apparatus comprises:

a backup module 10, configured to back up an old version database, wherein table structures of the old version database are stored;

an acquiring module 20, configured to clear records of all tables in a new version database, and acquire table structures of the new version database;

a comparing module 30, configured to compare the table structures of the old version database with the table structures of the new version database, and determine that the table structures change; and

a recovering module 40, configured to recover a backup of the old version database into the new version database according to a type of the change and a corresponding preset strategy.

This embodiment solves the problem in the related art that the old version database backup cannot be recovered into a new version database with the design of database structure having changed by analyzing the change of the table structures, and thereby the forward compatibility of database backup recovery is achieved.

Preferably, the comparing module 30 is configured to determine that the table structures change comprises: the comparing module 30 is configured to determine that at least one change as follows happens to the table structures of the new version database.

A table is deleted in the new version database.

A table is added in the new version database.

A table is renamed in the new version database.

A column is deleted in a table in the new version database.

A column is added in a table in the new version database.

A column is renamed in a table in the new version database.

The order of a column in a table changes in the new version database.

The data type of a column in a table changes in the new version database.

It can be very easy to identify the changes of the above eight categories by comparing the table structures.

Preferably, in the above apparatus, the corresponding preset strategy comprises at least one as follows.

For the change 1, the recovery of the deleted table is skipped over.

For the change 2, the recovery of the new added table is skipped over.

For the change 3, the renamed table in the backup is recovered into the renamed table in the new version database.

For the change 4, the recovery of the deleted column is skipped over.

For the change 5, if a default value is preset, then the new added column is set as the default value, and if no default value is preset, then the new added column is set as a NULL value, or an indicated value; or the recovery of the new added column is skipped over.

For the change 6, the renamed column in the backup is recovered into the renamed column in the new version database.

For the change 7, the column in the backup is recovered into the column in the new version database, according to the new order.

For the change 8, the value of the column in the backup is converted into a new data type, and then the value is recovered into the column of the new version database. If the value cannot be converted, then the column of the new version database is recovered as a designated value.

By performing the above compatible processing, all eight changes of the structure design of the new and old version databases can be adapted, and thereby the forward compatibility of database backup recovery is well achieved, which can be applied to most of the scenarios.

It can be known from the above description that, by the present invention, the database content can be recovered from the old version software environment into the new version software environment quickly, and the compatibility problem brought about by the changes of the database structure is solved. As to the difference of various different database structures, it is only required to simply modify the XML configuration file to meet the requirements of forwardly compatible backup recovery.

Apparently, those skilled in the art shall understand that the above modules and steps of the present invention can be realized by using general purpose calculating device, can be integrated in one calculating device or distributed on a network which consists of a plurality of calculating devices. Alternatively, the modules and the steps of the present invention can be realized by using the executable program code of the calculating device. Consequently, they can be stored in the storing device and executed by the calculating device, and in some cases, the shown or described steps can be performed in sequence other than herein, or they are made into integrated circuit module respectively, or a plurality of modules or steps thereof are made into one integrated circuit module. In this way, the present invention is not restricted to any particular hardware and software combination.

Above description is only to illustrate the preferred embodiments but not to limit the present invention. Various alterations and changes to the present invention are apparent to those skilled in the art. Any amendments, equivalent substitutions, improvements and etc. within the spirit and principle of the present invention are all concluded in the scope of the present invention.

1. A method for recovering a database backup, comprising:
backing up an old version database, wherein table structures of the old version database are stored;
acquiring table structures of an new version database;
comparing the table structures of the old version database with the table structures of the new version database, and determining that the table structures change; and
recovering the backup of the old version database into the new version database according to a type of the change and a corresponding preset strategy.

2. The method according to claim 1, wherein determining that the table structures change comprises: determining at least one change as follows happens to the table structures of the new version database:
a table is deleted in the new version database;
a table is added in the new version database;
a table is renamed in the new version database;
a column is deleted in a table in the new version database;
a column is added in a table in the new version database;
a column is renamed in a table in the new version database;
an order of a column in a table changes in the new version database; and
a data type of a column in a table changes in the new version database.

3. The method according to claim 2, wherein the corresponding preset strategy comprises at least one as follows:
for the change 1, skipping over the recovery of the deleted table;
for the change 2, skipping over the recovery of the new added table;
for the change 3, recovering the renamed table in the backup into the renamed table in the new version database;
for the change 4, skipping over the recovery of the deleted column;
for the change 5, if a default value is preset, then setting the new added column as the default value, and if no default value is preset, then setting the new added column as a NULL value, or an indicated value; or skipping over the recovery of the new added column;
for the change 6, recovering the renamed column in the backup into the renamed column in the new version database;
for the change 7, recovering the column in the backup into the column in the new version database according to the new order; and
for the change 8, converting the value of the column in the backup into the new data type, then recovering the value into the column of the new version database, and if the value cannot be converted, then recovering the column of the new version database as a designated value.

4. The method according to claim 3, wherein the method further comprises: creating a configuration file in advance, and recovering the backup of the old version database into the new version database by analyzing the configuration file, wherein the configuration file comprises at least one of the rules of performing the preset strategies 3, 5, 6, and 8.

5. The method according to claim 4, wherein the configuration file further comprises at least one rule as follows:
column modification rule: indicating to set the value of the column designated in the new version database to be the default value;
column deletion rule: indicating to set the value of the column designated in the new version database to be the NULL value;
table modification rule: indicating to use the combination of the column modification rule and the column deletion rule for a plurality of columns of the table in the new version database; and
postprocessing rule: indicating to modify the data in the new version database by executing a SQL sentence or a dedicated code segment on the basis that the backup has already been recovered into the new version database.

6. The method according to claim 3, wherein the method further comprises: creating an executive program in advance and executing at least one of the rules of the preset strategies 1, 2, 4, and 7 directly according to the executive program.

7. The method according to claim 1, wherein the backup of the old version database is recovered into the new version database by means of block copy (bcp).

8. The method according to claim 1, wherein the information of the table structures comprises: database name, table name, column name, column length and column data type.

9. An apparatus for recovering a database backup, comprising:
a backup module, configured to back up an old version database, wherein table structures of the old version database are stored;
an acquiring module, configured to clear records of all tables in a new version database, and acquire table structures of the new version database;
a comparing module, configured to compare the table structures of the old version database with the table structures of the new version database, and determine that the table structures change; and
a recovering module, configured to recover the backup of the old version database into the new version database according to a type of the change and a corresponding preset strategy.

10. The apparatus according to claim 9, wherein the comparing module determining that the table structures change comprises: the comparing module is configured to determine that at least one as follows happens to the table structures of the new version database:
a table is deleted in the new version database;
a table is added in the new version database;
a table is renamed in the new version database;
a column is deleted in a table in the new version database;
a column is added in a table in the new version database;
a column is renamed in a table in the new version database;
an order of a column in a table changes in the new version database; and
a data type of a column in a table changes in the new version database.

11. The apparatus according to claim 10, wherein the corresponding preset strategy comprises at least one as follows:
for the change 1, skipping over the recovery of the deleted table;
for the change 2, skipping over the recovery of the new added table;
for the change 3, recovering the renamed table in the backup into the renamed table in the new version database;
for the change 4, skipping over the recovery of the deleted column;
for the change 5, if a default value is preset, then setting the new added column as the default value, and if no default value is preset, then setting the new added column as a NULL value, or an indicated value; or skipping over the recovery of the new added column;
for the change 6, recovering the renamed column in the backup into the renamed column in the new version database;
for the change 7, recovering the column in the backup into the column in the new version database according to the new order; and
for the change 8, converting the value of the column in the backup into the new data type, then recovering the value into the column of the new version database, and if the value cannot be converted, then recovering the column of the new version database into a designated value.
